(19) United States
(12) Patent Application Publication
(10) Pub. No.: US 2020/0366038 A1
(43) Pub. Date: Nov. 19, 2020

(54) PUSH-ON RF CONNECTOR SERIES FOR IMPROVED CONTACT RETENTION

(71) Applicant: The Government of the United States of America, as represented by the Secretary of the Navy, Arlington, VA (US)

(72) Inventor: Rick W. Kindt, Arlington, VA (US)

(21) Appl. No.: 16/801,721

(22) Filed: Feb. 26, 2020

Related U.S. Application Data
(60) Provisional application No. 62/810,397, filed on Feb. 26, 2019.

(51) Int. Cl. H01R 24/40; H01R 13/6592

(52) U.S. Cl. CPC H01R 24/40; H01R 2103/00; H01R 13/6592

(57) ABSTRACT

Systems and devices are provided for push-on or blind-mate connectors that maintain the advantages of using push-on connectors over threaded connectors (e.g., linear engagement with a simple push) but increase the effective contact retention by a significant margin under typical conditions. For example, embodiments of the present disclosure provide push-on connectors that use a shielding layer that protects the engaged male and female components of the connector and prevents an engaged push-on connector from coming apart when force is applied to the connector or cable.

### CROSS REFERENCE TO RELATED APPLICATIONS

This application claims the benefit of U.S. Provisional Patent Application No. 62/810,397, filed on Feb. 26, 2019, which is incorporated by reference herein in its entirety.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; techtran@nrl.navy.mil, referencing Navy Case Number 110386-US2.

### FIELD OF THE DISCLOSURE

This disclosure relates to radio frequency cable connectors, including push-on connectors.

### BACKGROUND

Threaded connectors such as 3.5 mm, 2.92 mm, 2.42 mm, etc., are common commercial off the shelf (COTS) radio frequency (RF) connectors with retention for contacted parts, once engaged. The threaded barrels on the parts engage with significant holding power, so cables (for example) are not able to fall off during use. However, for tight spots or large numbers of connectors, threaded connectors become very inconvenient, since accessing the threads becomes difficult.

Push-on, press-on, or blind-mate connectors of which there are many examples (e.g., sub miniature push-on (SMP), mini-smp, smp-m, gppo, smp-s, g3po, mm4s, g4po, etc.), are significantly more convenient RF connectors because they engage simply by pressing the male/female connectors together. The press-on feature is very convenient, and in cases of large numbers of connectors or extremely tight working conditions, can be almost a necessity as there may not be space/room to thread many connectors together.

A disadvantage and complaint commonly experienced with press-on connectors is that they simply fall apart or break contact between the male/female connectors more easily than desired. This is less of an issue with the larger connector series which have greater force and retention, but for the smaller connector series, e.g. mini-smp, mm4s, etc., it becomes a greater issue of concern. The typical example is the case of cables, which can experience “pull” very easily along nearly any part of the cable, putting tension on the connection point and pulling the connectors apart.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 shows picture of exemplary components of push-on connectors in accordance with an embodiment of the present disclosure;

FIG. 2A shows a diagram of an exemplary push-on connector in accordance with an embodiment of the present disclosure;

FIG. 2B shows another diagram of an exemplary push-on connector in accordance with an embodiment of the present disclosure;

FIG. 3 shows another diagram of an exemplary push-on connector in accordance with an embodiment of the present disclosure;

FIG. 4 is another diagram of an exemplary push-on connector in accordance with an embodiment of the present disclosure;

FIG. 5 is a diagram of a cross-section view of the exemplary push-on connector of FIG. 4 when disengaged in accordance with an embodiment of the present disclosure;

FIG. 6 is a diagram of a cross-section view of the exemplary push-on connector of FIG. 4 when engaged in accordance with an embodiment of the present disclosure;

FIG. 7 is another diagram of an exemplary push-on connector in accordance with an embodiment of the present disclosure;

FIG. 8 is a cross-section view of the male interface of FIG. 7 in accordance with an embodiment of the present disclosure;

FIG. 9 is a diagram of a cross-section view of the exemplary push-on connector of FIG. 7 when disengaged in accordance with an embodiment of the present disclosure; and

FIG. 10 is a diagram of a cross-section view of the exemplary push-on connector of FIG. 7 when engaged in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### 1. Overview

Embodiments of the present disclosure provide a sub-series of push-on or blind-mate connectors that maintain the advantages of using push-on connectors over threaded connectors (e.g., linear engagement with a simple push) but increase the effective contact retention by a significant margin under typical conditions. For example, embodiments of the present disclosure provide push-on connectors that use a shielding layer that protects the engaged male and female components of the connector and resists detachment of an engaged push-on connector when force is applied to the connector or cable (e.g., via pulling on the cable, applying a normal force to the cable, etc.).

### 2. Push-On Connectors with Shielding

Embodiments of the present disclosure provide press-on connectors that maintain connection, particularly in the case of cable pull, far better than the current COTS connectors. Embodiments of the present disclosure exploit the observation that undesired “de-mating” of the connectors is not often caused by application of linear force on the connector contacts, but rather largely lateral or side-to-side moment on the point of connector contact. Basically, it is a lot easier to break the connector contact by bending the parts or pulling them at right angles, as opposed to pulling the connectors straight apart. In other words, de-mating the connectors by pulling them straight apart requires significantly greater applied force, whereas perpendicular forces can break the contact more easily than intended. In remediation, embodiments of the present disclosure include a short rigid sleeve over the connector contact points to prevent any forces (other than the intended linear extraction force) from bearing on the connector contacts.

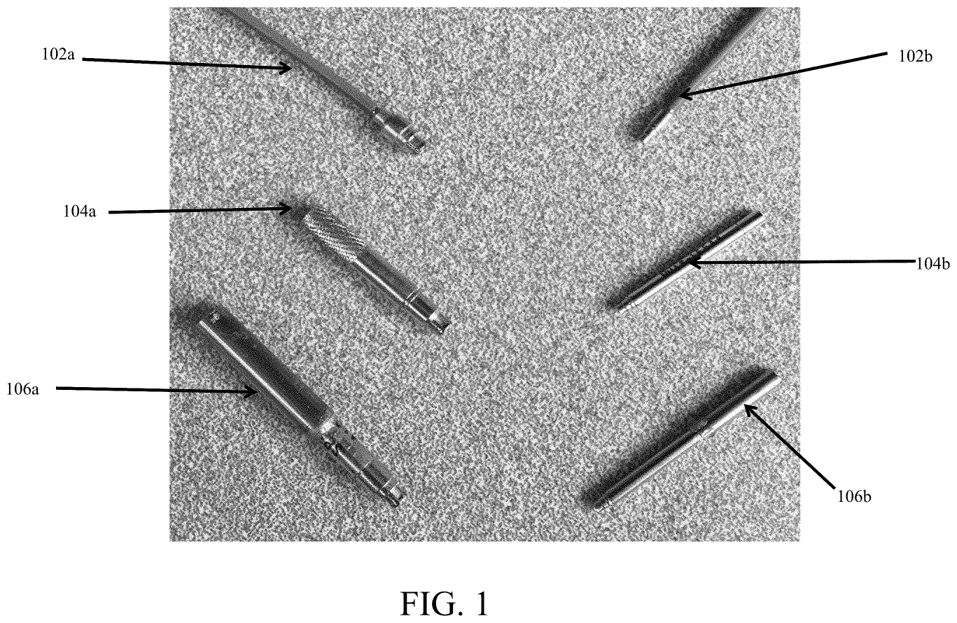

FIG. 1 shows picture of exemplary components of push-on connectors in accordance with an embodiment of the present disclosure. FIG. 1 shows COTS cable connectors 102, exemplary connector savers 104 (e.g., male-female adapters or bullets) that can mate on the ends of the cable connectors 102. FIG. 1 also shows examples of shielding 106 in accordance with an embodiment of the present disclosure. In an embodiment, shielding 106 can be made by bonding short metal sleeves on one end of the bullets of connector savers 104 (e.g., on the male or female end of the male/female adapter). In an embodiment, shielding 106 can slightly increase the length and diameter of the component, but when the components are engaged on the cable, they can slide over the contact point between the female connector on the cable and the male portion of the adapter, thus not taking any additional space when engaged.

In an embodiment, shielding 106 protects the contact points between the cable end and the adapter, very effectively preventing any side-to-side force on the contact point. In an embodiment, this does not change the linear engagement/disengagement force required to active the component, but, by preventing any moment perpendicular to the connector contacts, results in the component staying in place far better, regardless of any inadvertent tension on the cable, for example.

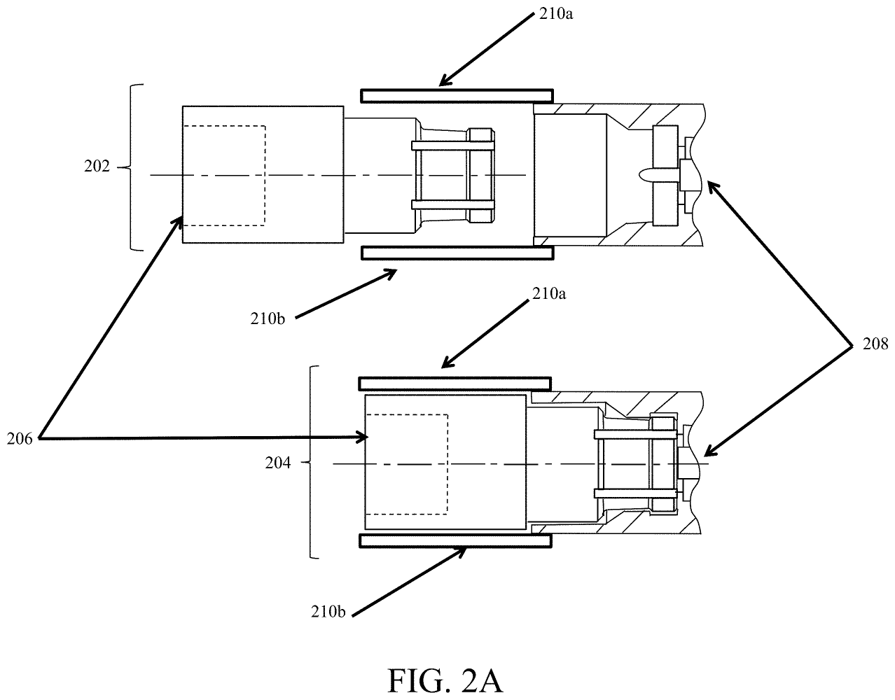

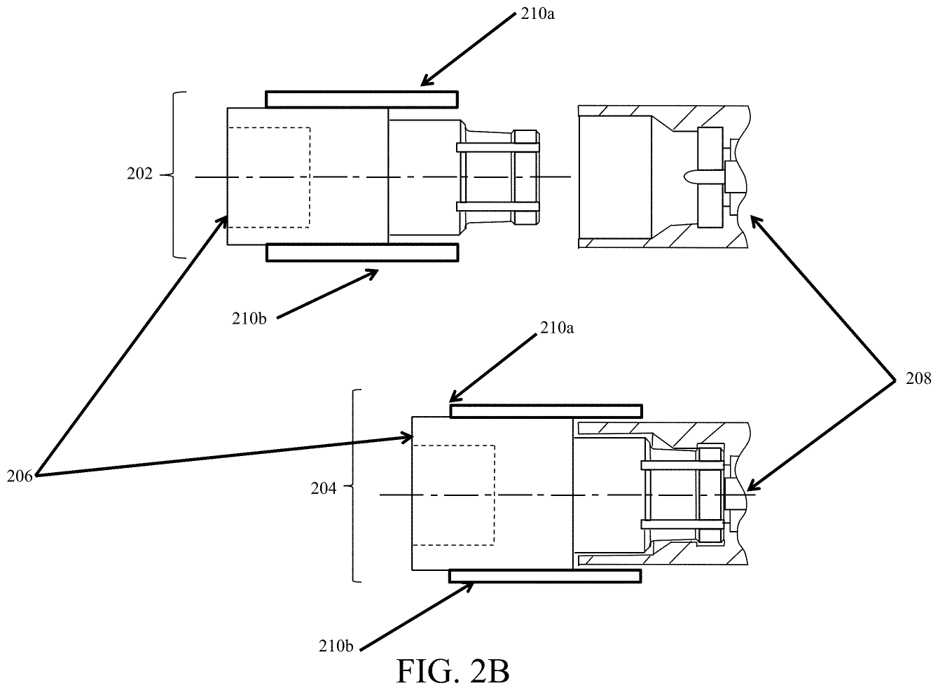

FIG. 2A shows a diagram of an exemplary push-on connector in accordance with an embodiment of the present disclosure. FIG. 2A shows diagrams of the same push-on connector when disengaged 202 and when engaged 204. The push-on connector of FIG. 2A includes a female interface 206 that engages with a male interface 208. In FIG. 2A, shielding 210 is applied over male interface 208. In an embodiment, shielding 210 slides over female interface 206 when the connector is engaged 204.

The length of shielding 210 can vary among embodiments of the present disclosure. In an embodiment, the length of shielding 210 is long enough such that it covers at least the female interface 206 and male interface 208 of an engaged connector coupled to two cables but not portions of the cables extending from female interface 206 and male interface 208. In an embodiment, the length of shielding 210 is long enough such that it covers at least the female interface 206 and male interface 208 of an engaged connector, as well as portions of the cables extending from female interface 206 and male interface 208. In an embodiment, the length of shielding 210 covers a portion of the female interface 206 and a portion of the male interface 208 of an engaged connector.

While shielding 210 is shown applied over male interface 208 in FIG. 2A, it should be understood that shielding 210 can also be applied to female interface 206 and can be configured to slide over male interface 208 when the push-on connector of FIG. 2A is engaged. FIG. 2B shows another diagram of an exemplary push-on connector in accordance with an embodiment of the present disclosure. In FIG. 2B,n shielding 210 is applied over female interface 206. In an embodiment, shielding 210 slides over male interface 208 when the connector is engaged 204. In an embodiment, shielding 210 is formed from a metallic material (e.g., brass or steel, such as passivated steel). However, it should be understood that shielding 210 can be formed from any rigid material in accordance with embodiments of the present disclosure.

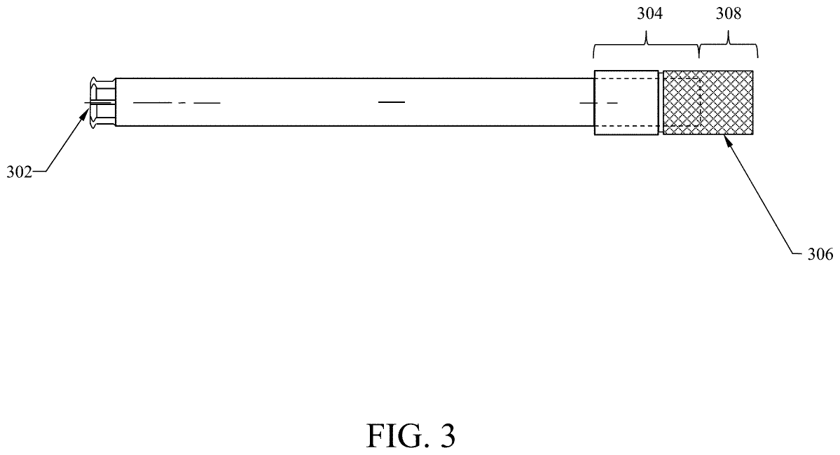

FIG. 3 shows another diagram of an exemplary push-on connector in accordance with an embodiment of the present disclosure. FIG. 3 shows a female interface 302 and a male interface 304. In an embodiment, a female interface 302 of a first connector or cable can be configured to slide through knurl 306 to engage with a male interface 204 of a second connector or cable. In an embodiment, shielding 308 is incorporated into male interface 304 by extending knurl 306 such that a portion of knurl 306 (e.g., shielding 308) slides over a portion of an engaged female interface (such as female interface 302).

### 3. Push-On Connectors with Shielding and Additional Components

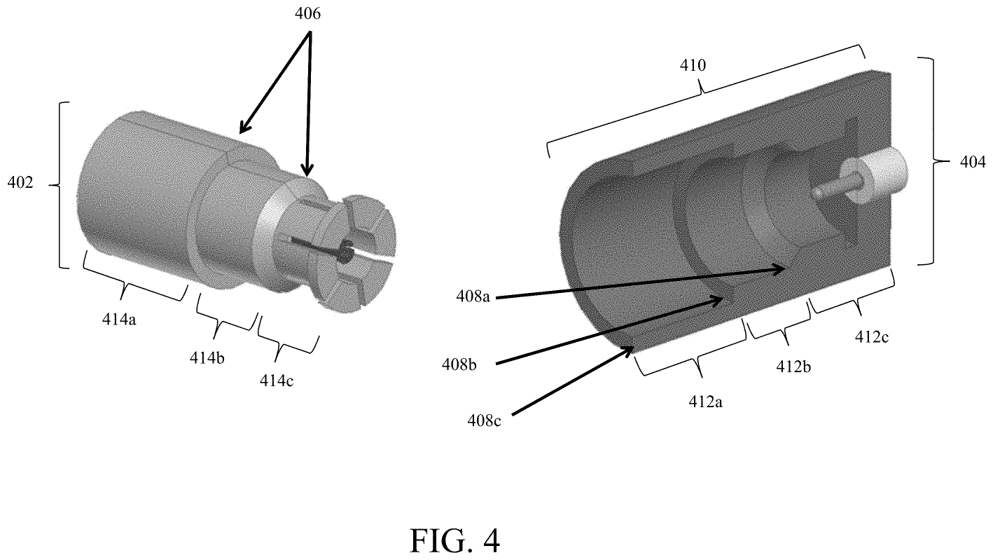

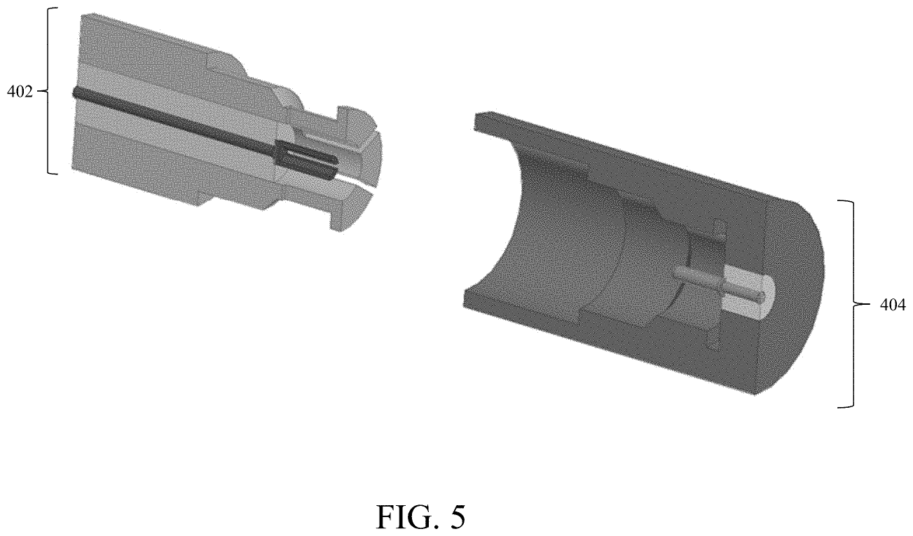

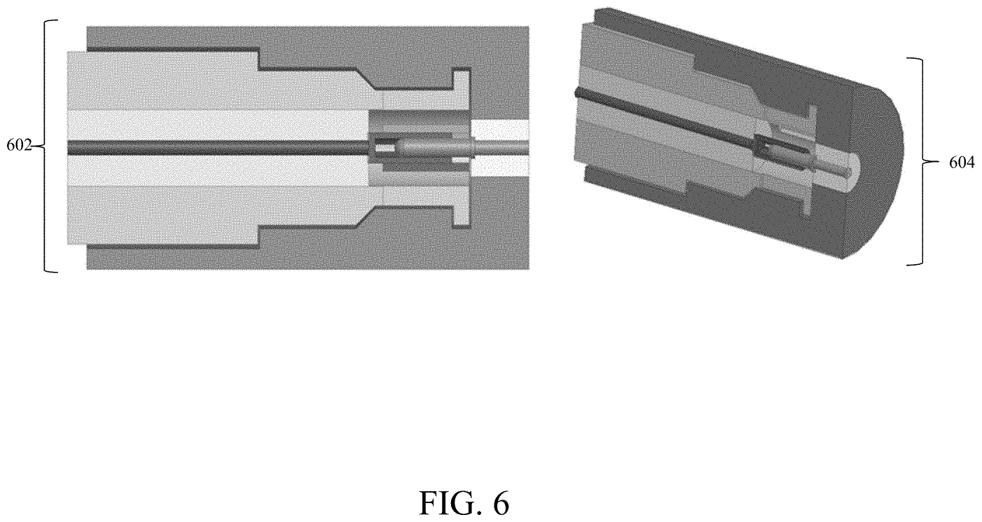

FIG. 4 is another diagram of an exemplary push-on connector in accordance with an embodiment of the present disclosure. FIG. 4 shows a female interface 402 and a male interface 404 of an exemplary push-on connector. As shown in FIG. 4, female interface 402 includes a plurality of ridges 406 forming a plurality of contact areas 414. Further, as shown in FIG. 4, male interface 404 includes a plurality of contact areas 412 of differing depths etched into shielding 410, terminating at respective points 408. In an embodiment, contact area 412a covers contact area 414a of female interface 402 when female interface 402 engages with male interface 404, thereby enabling all portions of female interface 402 and male interface 404 to be protected by shielding 410 when female interface 402 engages with male interface 404. In an embodiment, ridges 406, contact areas 412, and contact areas 414 provide additional retention when female interface 402 engages with male interface 404. FIG. 5 is a diagram of a cross-section view of the exemplary push-on connector of FIG. 4 when disengaged in accordance with an embodiment of the present disclosure. FIG. 6 is a diagram of a cross-section view of the exemplary push-on connector of FIG. 4 when engaged in accordance with an embodiment of the present disclosure.

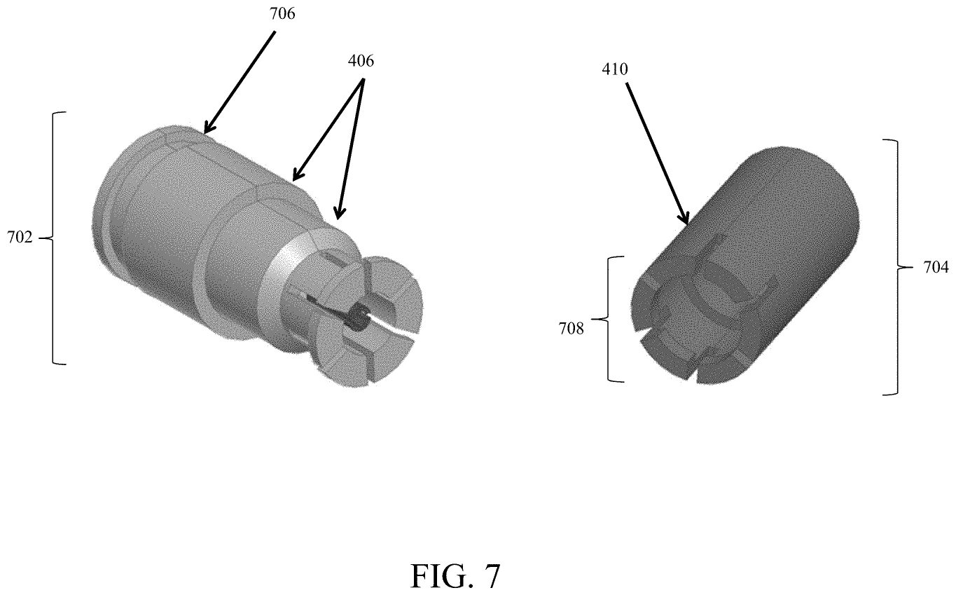

FIG. 7 is another diagram of an exemplary push-on connector in accordance with an embodiment of the present disclosure. FIG. 7 shows a female interface 702 and a male interface 704 of an exemplary push-on connector. As shown in FIG. 7, female interface 702 also includes a retention groove 706 in addition to ridges 406. Further, in an embodiment, male interface 704 includes a plurality of fingers 708 (e.g., in an embodiment, spring fingers). In an embodiment, fingers 708 are configured to slide into retention groove 706 when female interface 702 engages with male interface 702. In an embodiment, fingers 708 and retention groove 706 provide additional retention when female interface 702 engages with male interface 704.

While fingers 708 are shown in FIG. 7, it should be understood that male interface 704 can components other than fingers 708 configured to slide into retention groove 706. For example, in an embodiment, fingers 708 can be replaced with a single protrusion, extending from shielding 410, that is configured to slide into retention groove 706. Further, in an embodiment, retention groove 706 is not present, and instead fingers 708 are configured to extend over the outer edge of the housing female interface 702 to provide additional retention.

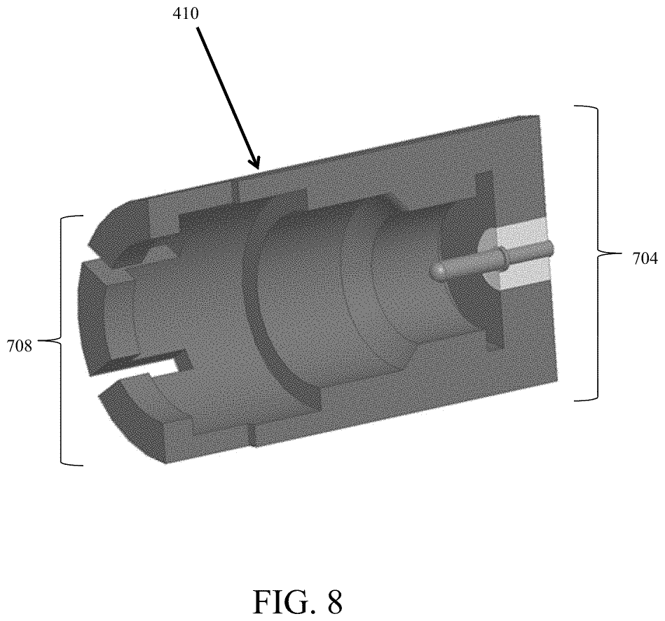

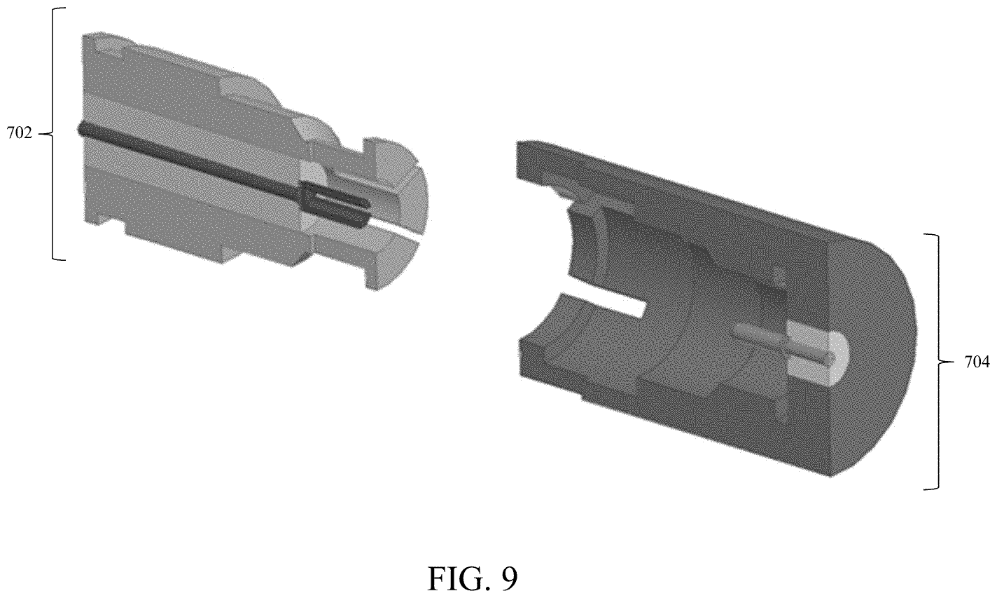

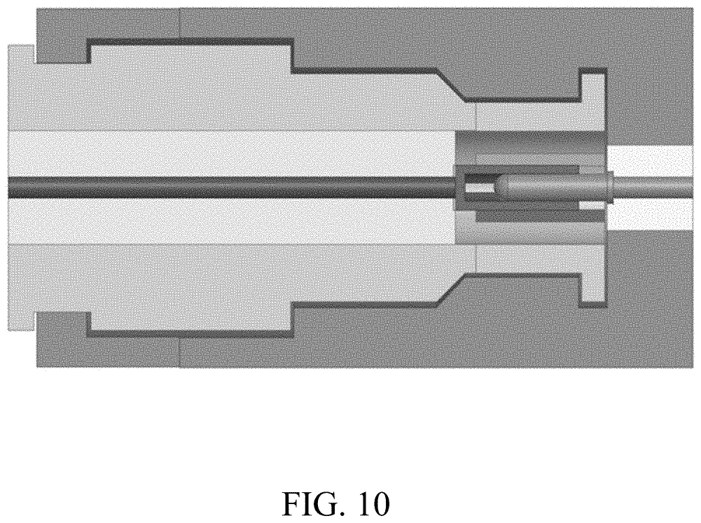

FIG. 8 is a cross-section view of the male interface 704 of FIG. 7 in accordance with an embodiment of the present disclosure. FIG. 9 is a diagram of a cross-section view of the exemplary push-on connector of FIG. 7 when disengaged in accordance with an embodiment of the present disclosure. FIG. 10 is a diagram of a cross-section view of the exemplary push-on connector of FIG. 7 when engaged in accordance with an embodiment of the present disclosure. While ridges 406 and grooves 408 are shown in FIGS. 7-10, it should be understood that embodiments of the present disclosure can include retention groove 706 and fingers 708 without including ridges 406 and grooves 408.

### 4. Exemplary Advantages

Embodiments of the present disclosure provide convenient press-on connectors with improved retention. Embodiments of the present disclosure can be implemented using a very thin but rigid sleeve section, such that the effective diameter of the connector can be nearly the same as the original connector series without shielding. This concept can be applied to all existing connector series with equal effectiveness.

### 5. Conclusion

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

1. A radio frequency (RF) cable configured to be coupled with a push-on connector, the RF cable comprising:
a male interface coupled to a first portion of the RF cable;
a female interface coupled to a second portion of the RF cable, wherein the female interface is configured to engage with the male interface; and
shielding coupled to the male interface, wherein the shielding is configured to cover the male interface and the female interface when the female interface is engaged with the male interface.

2. The RF cable of claim 1, wherein the shielding is applied over the male interface.

3. The RF cable of claim 1, wherein the shielding extends from the male interface.

4. The RF cable of claim 1, further comprising:
a plurality of contact areas etched into the shielding; and
a plurality of ridges extending from the female interface, wherein the plurality of ridges are configured to slide into the plurality of contact areas when the female interface is engaged with the male interface.

5. The RF cable of claim 4, wherein an outer contact area of the plurality of contact areas is configured to cover an outer ridge of the plurality of ridges when the female interface is engaged with the male interface, thereby enabling the male interface and the female interface to be covered by the shielding when the female interface is engaged with the male interface.

6. The RF cable of claim 1, further comprising:
a retention groove etched into the female interface; and
a plurality of fingers extending from the shielding, wherein the plurality of fingers are configured to slide into the retention groove when the female interface is engaged with the male interface.

7. The RF cable of claim 1, further comprising:
a plurality of contact areas etched into the shielding;
a plurality of ridges extending from the female interface, wherein the plurality of ridges are configured to slide into the plurality of contact areas when the female interface is engaged with the male interface;
a retention groove etched into the female interface; and
a plurality of fingers extending from the shielding, wherein the plurality of fingers are configured to slide into the retention groove when the female interface is engaged with the male interface.

8. A male component of a push-on connector, comprising:
a male interface configured to engage with a female interface; and
shielding coupled to the male interface, wherein the shielding is configured to cover the male interface and the female interface when the male interface is engaged with the female interface.

9. The male component of the push-on connector of claim 8, wherein the shielding is applied over the male interface.

10. The male component of the push-on connector of claim 8, wherein the shielding extends from the male interface.

11. (canceled)

12. The male component of the push-on connector of claim 8, further comprising:
a plurality of contact areas etched into the shielding, wherein the plurality of contact areas are configured to couple with a plurality of ridges of the female interface when the male interface is engaged with the female interface, wherein an outer contact area of the plurality of contact areas is configured to cover an outer ridge of the plurality of ridges when the female interface is engaged with the male interface, thereby enabling the male interface and the female interface to be covered by the shielding when the female interface is engaged with the male interface.

13. The male component of the push-on connector of claim 8, further comprising:
a plurality of fingers extending from the shielding, wherein the plurality of fingers are configured to slide into a retention groove etched into the female interface when the female interface is engaged with the male interface.

14. The male component of the push-on connector of claim 8, further comprising:
a plurality of contact areas etched into the shielding, wherein the plurality of contact areas are configured to couple with a plurality of ridges of the female interface when the male interface is engaged with the female interface; and
a plurality of fingers extending from the shielding, wherein the plurality of fingers are configured to slide into a retention groove etched into the female interface when the female interface is engaged with the male interface.

15. The male component of the push-on connector of claim 8, further comprising:
a plurality of fingers extending from the shielding, wherein the plurality of fingers are configured to slide over an edge of a housing of the female interface when the female interface is engaged with the male interface.

16. A female component of a push-on connector, comprising:
a female interface configured to engage with a male interface; and
shielding coupled to the female interface, wherein the shielding is configured to cover the male interface and the female interface when the male interface is engaged with the female interface.

17. The female component of the push-on connector of claim 16, wherein the shielding is applied over the female interface.

18. The female component of the push-on connector of claim 16, wherein the shielding extends from the female interface.

19. The female component of the push-on connector of claim 16, further comprising:
a plurality of ridges, wherein the plurality of ridges are configured to couple with a plurality of contact areas of the male interface when the male interface is engaged with the female interface, and wherein an outer contact area of the plurality of contact areas is configured to cover an outer ridge of the plurality of ridges when the female interface is engaged with the male interface, thereby enabling the male interface and the female interface to be covered by the shielding when the female interface is engaged with the male interface.

20. The male component of the push-on connector of claim 16, further comprising:
a retention groove etched into a housing of the female interface, wherein the retention groove is configured to couple with a plurality of fingers of the male interface when the female interface is engaged with the male interface.

21. The female component of the push-on connector of claim 16, further comprising:
a plurality of ridges, wherein the plurality of ridges are configured to couple with a plurality of contact areas of the male interface when the male interface is engaged with the female interface, and wherein an outer contact area of the plurality of contact areas is configured to cover an outer ridge of the plurality of ridges when the female interface is engaged with the male interface, thereby enabling the male interface and the female interface to be covered by the shielding when the female interface is engaged with the male interface; and
a retention groove etched into a housing of the female interface, wherein the retention groove is configured to couple with a plurality of fingers of the male interface when the female interface is engaged with the male interface.
